(19) United States
(12) Patent Application Publication
(10) Pub. No.: US 2023/0180764 A1
(43) Pub. Date: Jun. 15, 2023

(54) THREE-DIMENSIONALLY PRINTABLE ANTIVIRAL FILAMENT

(71) Applicant: Essentium IPCo, LLC, Pflugerville, TX (US)

(72) Inventors: Nirup Nagabandi, Pflugerville, TX (US); Elisa Teipel, Pflugerville, TX (US); Kevin Holder, Pflugerville, TX (US); Charles Brandon Sweeney, Pflugerville, TX (US); Chad Eichele, Lake Forest, CA (US)

(21) Appl. No.: 17/997,414

(22) PCT Filed: Apr. 26, 2021
(86) PCT No.: PCT/US21/29075

§ 371 Date: Oct. 28, 2022

Related U.S. Application Data
(60) Provisional application No. 63/016,749, filed on Apr. 28, 2020.

(51) Int. Cl. A01N 59/16; A01N 25/34; B82Y 30/00

(52) U.S. Cl. CPC A01N 59/16; A01N 25/34; B82Y 30/00

(57) ABSTRACT

An antiviral filament and an antiviral three-dimensionally printed component including an antiviral polymer including a base polymer, and an antiviral agent incorporated in the base polymer, wherein the antiviral agent exhibits a phase transition temperature of 200 degrees Centigrade or greater. A method of fabricating a three-dimensional component including feeding an antiviral filament into an extrusion nozzle, the antiviral filament comprising an antiviral polymer; applying heat and pressure to the antiviral filament to melt the antiviral filament in the extrusion nozzle; extruding the antiviral filament from the extrusion nozzle; depositing the extruded antiviral filament into layers; and forming a three-dimensional component from the layers of extruded antiviral filament.

### CROSS-REFERENCE TO RELATED APPLICATIONS

The present application is a national stage of International Application No.: PCT/US21/29075, filed on Apr. 26, 2021, which claims the benefit of U.S. Provisional Application No. 63/016,749, filed on Apr. 28, 2020, the teachings of which are incorporated herein.

### FIELD

The present disclosure is directed to three-dimensionally (3D) printable filament and method of forming such filament into three-dimensionally printed components, wherein the filament exhibits antiviral activity, as well as, in aspects, antimicrobial activity.

### INTRODUCTION

Infectious diseases are typically caused by bacteria, fungi, viruses, parasites, or other pathogens. Viruses alone are believed to be responsible for up to 60% of human infections. More than 1000 types of viruses are known to exist, and viruses are capable of mutation, some mutations creating resistance to antiviral drugs and immune response in patients. Viruses may lead to several symptoms varying in scope, including minor aches, chills, fever, congestion, pneumonia, nerve damage, and hemorrhaging. In some circumstances, these symptoms can lead to physical impairment or even death. Changes in climate, forest cover, water deposits, lake and river levels, and demographics have caused the appearance of viruses associated with serious or highly contagious diseases such as hemorrhagic fever viruses. From time to time, the spread of disease, and particularly viral disease, turns into an epidemic, where the disease spreads regionally, or even a pandemic, where the disease spreads globally often due to increased trade across borders and international travel.

Infectious diseases, caused by viruses, may pass to people from other people, insects, or other animals, through consuming contaminated foods or water, or through environmental exposure through soils, vegetation, or water. Viruses may also pass through respiratory droplet transmission. When individuals cough, sneeze, or talk, aerosol droplets are generated and released which contain the virus and deposit themselves on nearby surfaces. Some populations, such as children and healthy adults, may be asymptomatic when infected with a given virus, allowing for undetected spread of the disease. In addition, some viruses, such as coronavirus (SARS-CoV-2) causing COVID 19, can live on surfaces for a period of time. Some viruses can live on surfaces for a few hours, if not days, depending on the material the surface is made from and environmental conditions.

To reduce the incidence of viral transmission various methods of mitigation can be taken, including cleaning and sterilization of surfaces, handwashing, isolation of infected persons or animals to reduce contact with other people or animals, and removal of environmental sources. However, there is a need for cleaner surfaces across medical, manufacturing, transport, and logistics industries to avoid or reduce the spread of infectious disease and to prevent epidemics or pandemics caused by viruses such as SARS-CoV-2, flu virus, etc. Viruses are particularly difficult to eliminate as the protective coating, typically a lipid bi-layer or capsid, as well as the nucleic acids contained therein must be destroyed. Whereas in other microorganisms such as bacteria and fungi, only a vital function of the organism or certain component of the organism needs to be destroyed, rather than the entire organism. Thus, while the current solutions are effective, room remains for improvement in providing cleaner surfaces across the medical, industrial, transport and logistics industries.

### SUMMARY

According to various aspects, the present disclosure is directed to an antiviral filament. The antiviral filament includes an antiviral polymer including a base polymer and an antiviral agent incorporated in the base polymer, wherein the antiviral agent exhibits a phase transition temperature of 200 degrees Centigrade or greater.

In further aspects of the above, the antiviral agent includes at least one of metal nanoparticles, metal ions, and metal ion containing zeolites. In additional aspects, such antiviral agent is present in a range of 0.05 percent to 2 percent by weight of the total weight of the antiviral polymer. In additional aspects, such antiviral agent includes at least one of copper, gold, silver, an S block metal having a molecular mass greater than 28 and, a D block metal having a molecular mass greater than 28. In additional aspects, such antiviral agent includes metal nanoparticles and the metal nanoparticles exhibit a size in a range of 1 nm to 250 nm.

In any of the aspects of the above, the antiviral agent includes at least one of bisbiguanides, hypericin, pseudo-hypericin, quaternary ammonium salts and quaternary phosphonium salts. In additional aspects, such antiviral agent is present in the antiviral polymer in a range of 0.01 percent to 2 percent by weight of the total weight of the antiviral polymer.

In any of the aspects of the above, the antiviral agent includes phenols. In additional aspects, such antiviral agent is present in a range of 5 percent to 20 percent by weight of the total weight of the antiviral polymer. In additional aspects, the phenols include tannic acid.

In any of the aspects of the above, the antiviral filament comprises a core and a sheath disposed on at least a portion of the core, wherein at least one of the sheath and the core is formed from the antiviral polymer. In additional aspects, the sheath and the core both include the same base polymer.

According to various aspects of the present disclosure, the present disclosure is directed to a method of fabricating a three-dimensional component. The method includes feeding an antiviral filament into an extrusion nozzle, wherein the antiviral filament includes an antiviral polymer including a base polymer and an antiviral agent incorporated in the base polymer, wherein the antiviral agent exhibits a phase transition temperature of 200 degrees Centigrade or greater. The method further includes applying heat and pressure to the antiviral filament to melt the antiviral filament in the extrusion nozzle, extruding the antiviral filament from the extrusion nozzle, depositing the extruded antiviral filament into layers, and forming a three-dimensional component from the layers of extruded antiviral filament.

According to various aspects, the present disclosure is directed to an antiviral three-dimensional printed component including a plurality of layers of an antiviral filament. The antiviral filament including an antiviral polymer including a base polymer and an antiviral agent incorporated in the base polymer, wherein the antiviral agent exhibits a phase transition temperature of 200 degrees Centigrade or greater.

In aspects of the above, the antiviral agent includes at least one of metal nanoparticles, metal ions, and metal ion containing zeolites. In additional aspects, such antiviral agent is present in a range of 0.05 percent to 2 percent by weight of the total weight of the antiviral polymer. In additional aspects, such antiviral agent includes at least one of copper, gold, silver, an S block metal having a molecular mass greater than 28 and, a D block metal having a molecular mass greater than 28. In additional aspects, such antiviral agent includes metal nanoparticles, the metal nanoparticles exhibit a size in a range of 1 nm to 250 nm.

In any of the above aspects, the antiviral agent includes at least one of bisbiguanides, hypericin, pseudo-hypericin, quaternary ammonium salts and quaternary phosphonium salts. In additional aspects, such antiviral agent is present in the antiviral polymer in a range of 0.01 percent to 2 percent by weight of the total weight of the antiviral polymer.

In any of the above aspects, the antiviral agent includes phenols. In additional aspects, such antiviral agent is present in a range of 5 percent to 20 percent by weight of the total weight of the antiviral polymer. In additional aspects, the phenols include tannic acid.

### BRIEF DESCRIPTION OF THE DRAWINGS

The drawings described herein are for illustration purposes only and are not intended to limit the scope of the present disclosure in any way.

FIG. 1A is an illustration of a cross-section of a 3D printable monofilament according to an embodiment of the present disclosure;

FIG. 1B is an illustration of a cross-section of a 3D printable multicomponent filament according to an embodiment of the present disclosure;

FIG. 2A is an illustration of an aspect of a multilayer filament according to an embodiment of the present disclosure;

FIG. 2B is an illustration of an aspect of a multilayer filament according to an embodiment of the present disclosure;

FIG. 2C is an illustration of an aspect of a multilayer filament according to an embodiment of the present disclosure;

FIG. 2D is an illustration of an aspect of a multilayer filament according to an embodiment of the present disclosure;

FIG. 3 is a schematic of a 3D printer nozzle and a 3D printed component according to an embodiment of the present disclosure; and

FIG. 4 is a flow chart of a method of printing with a 3D filament and a 3D printed component according to an embodiment of the present disclosure.

### DETAILED DESCRIPTION

The following description is merely exemplary in nature and is not intended to limit the present disclosure, application, or uses.

The present disclosure is directed to three-dimensionally (3D) printable antiviral filament and method of forming such antiviral filament into three-dimensional components by three-dimensional printing, wherein the antiviral filament, or at least a portion thereof, includes one or more antiviral agents in a base polymer and exhibits antiviral activity, as well as, in aspects, antimicrobial activity. Antimicrobial agents are understood herein as agents that kill or inhibit the growth of microorganisms such as bacteria, viruses, fungi, and protozoa, as well as other types of microorganisms. Antiviral agents are understood herein as antimicrobial agents that kill or inhibit the growth of viruses. Antiviral agents are also understood to be effective against other pathogens. As noted above, microorganisms may spread through contact with contaminated surfaces. By incorporating antiviral agents into 3D printable filaments, the antiviral may kill or otherwise inhibit viruses, and in further aspects other microorganisms, on the surface of 3D printed components formed with the filaments.

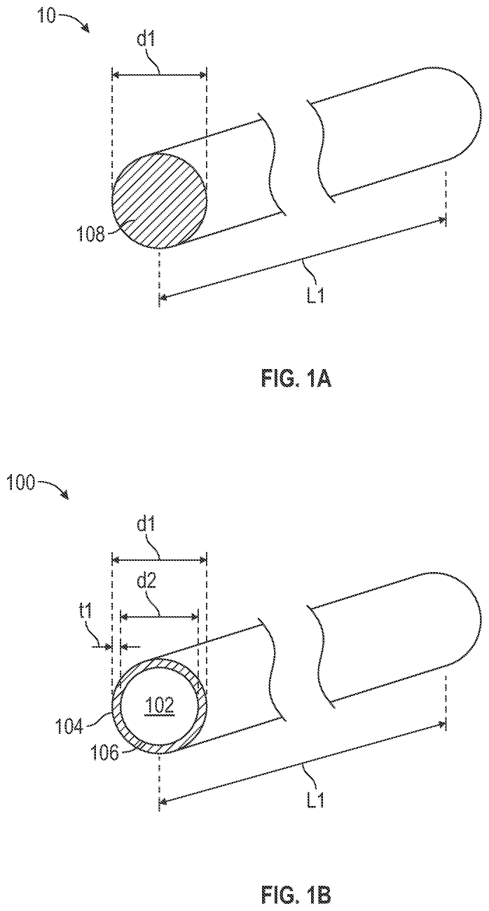

FIG. 1A and FIG. 1B illustrate aspects of the filament 10, 100. The antiviral filament 10, 100, exhibits a diameter d1 in the range of 0.5 mm to 5 mm, including all values and ranges therein, such as 1 mm to 3 mm, 1.75 mm, 2.85 mm, etc. The antiviral filament also exhibits an ovality that is in the range of 0 to 0.5, including all values and ranges therein. In aspects, the filament also is also rigid withstand a loading of 1 N to 200 N, including all values and ranges therein, applied along the length of the filament without buckling, but flexible enough to be spooled. Accordingly, in aspects, the filament exhibits a flexural modulus as measured in accordance with ASTM D790A-17, Method 1, 1.3 mm/min, in the range of 500 MPa to 4,000 MPa, including all values and ranges therein, and preferably 1,000 MPa to 3,000 MPa.

In addition, as alluded to above, the antiviral filament is formed from an antiviral polymer including one or more base polymers. The base polymers include at least one of a thermoplastic polymer and a thermoplastic elastomer polymer. Thermoplastic polymers include, in aspects, polyethylene terephthalate, polyphthalamide, co-polyester terephthalate, polyethersulfone, polyphenylene sulfide, polysulfone, polymethyl methacrylate, polyether ketone, polyether ether ketone, polyphenylsulfone, polyetherimide, poly(lactic acid), polyvinylidene fluoride, polyoxymethylene, polyamide, polyvinyl acetate, polycarbonate, thermoplastic elastomer including thermoplastic urethane, thermoplastic elastomer vulcanates, and styrenic block copolymers such as acrylonitrile styrene acrylate, high-impact polystyrene, acrylonitrile butadiene styrene, and polyolefins such polypropylene. The thermoplastic elastomers, in aspects, exhibit a hardness in the range of 25 Shore A to 90 Shore D, including all values and ranges therein. It should be appreciated that the base polymer material may include co-polymers or mixtures of the base polymers noted above, including mixtures of thermoplastic polymers, mixtures of thermoplastic elastomers, and mixtures of thermoplastic polymers and thermoplastic elastomers. In aspects, the base polymer is present in at least 25 percent (%) by weight of the total weight of the antiviral polymer, such as in the range of 25% by weight to 99.5% by weight of the total weight of the antiviral polymer. In further aspects, such as in the case of a multicomponent filament that includes a polymer component without an antiviral agent, a base polymer is present in at least 25 percent (%) by weight of the total weight of the polymer, such as in the range of 25% by weight to 99.5% by weight of the total weight of the polymer component.

The antiviral filament also includes one or more antiviral agents included in the antiviral polymer. As noted above, the antiviral agents interact with microorganisms through electrostatic charges, disrupt the surface chemistry of the microorganisms, membrane interactions and destroy the lipid bilayer, chemical interaction with proteins or protein components like sulfur and nitrogen present inside and, on the virus, and destroy the virus or as biocidal and poison the microorganisms. The antiviral agent also provides, in aspects, other antimicrobial activity. In aspects, one or more antiviral agents are present at a level of at least 0.01 weight percent of the total weight of the base polymer and up to 20 weight percent of the total weight of the antiviral polymer, including all values and ranges therein, such as 0.01 to 2 percent by weight, 0.5 percent by weight to 2 percent by weight, or 5 percent by weight to 20 percent by weight of the total weight of the antiviral polymer.

Antiviral agents for use herein include at least one of: a) an inorganic agent and b) an organic agent. In aspects, both inorganic and organic antiviral agents are used. In further aspects, the antiviral agents exhibit a phase transition temperature, such as a melting point or boiling point at temperatures of 200° C. or greater, such as in the range of 200° C. to 600° C., including all values and ranges therein. In aspects, at least 95% of the antiviral agent present in the filament before extrusion are present in the bead after extrusion through an opening in a nozzle of a three-dimensional printer. In aspects, the opening has a diameter in the range of 0.1 mm to 1.2 mm, including all values and ranges therein.

In aspects, the antiviral agents are inorganic and include at least one of a plurality of metal nanoparticles, a plurality of metal ions, and a plurality of metal ion containing zeolites. The metal nanoparticles include at least one of copper, gold, and silver as well as S and D block metals of relatively high molecular mass greater than 28. In aspects, the metal nanoparticles have a diameter in the range of 250 nanometers or less, including all values and increments in the range of 1 nm to 250 nm, 1 nm to 10 nm, 10 nm to 50 nm, etc. The metal ions include, for example, at least one of copper and silver. In aspects, the metal ions are provided in the form of metal salts and chelates. Zeolites include, for example, sodium aluminosilicate amended to include at least one of silver and copper. In aspects, the zeolite powders exhibit a particle size (longest linear dimension) in the range of 10 microns to 100 microns, including all values and ranges therein. Without being bound to any particular theory, it is thought that metals, metal ions, and zeolites containing metal ions attack the pathogen by entering the host surface by way of positive charges that attract negatively charged pathogens, trapping and killing them. Metal ions include cations, such as Lewis acids that interact with sulfur and nitrogen groups and hence can disrupt many bioprocesses and bio-organisms. Metal ions interact with thiol and amino groups of proteins on lipid bilayers, membranes, capsid and nucleic acid of pathogens and make them inactive. Metallic nanoparticles and metal salts release metal ions when they come in to contact with water molecules hence atmospheric moisture typically can affect continuous release of metal ions from nanoparticles for many months if not years. In viruses, the silver ion is reactive with lipid bilayer and protein present on capsid and the nucleic acid. Copper is understood to behave in a similar manner. These antiviral agents are provided in an amount in the range of 0.05 to 2 percent by weight of the total weight of the antiviral polymer, including all values and ranges therein.

In yet further aspects, the antiviral agents include synthetically derived organic compounds including bis-biguanides, hypericin, pseudo-hypericin, quaternary ammonium salts and quaternary phosphonium salts. Without being bound to any particular theory, bisbiguanides owing to their chemical structure and properties are able to interact with viral envelope and thus disinfect viruses. Examples of bisbiguanides include octenidine dihydrochloride and chlorhexidine have melting and boiling points in the range of 220 degrees Celsius and 600 degrees Celsius. Without being bound to any particular theory, quaternary ammonium salts possess reactive groups that have damaging effect on the proteins embedded in the envelope of viruses and thus disinfecting viruses. The quaternary ammonium salt is adsorbed on the viral envelop, followed by diffusion through the envelope and, or binding to the cytoplasm to disrupt it and kill the virus. In aspects, the quaternary ammonium salts include at least one alkyl chain in the range of 8 to 16 carbons and 3 methyl groups. Examples of quaternary ammonium salts for use herein include, for example, at least one of benzalkonium chloride, benzethonium chloride, methylbenzethonium chloride, cetalkonium chloride, cetylpyridinium chloride, cetrimonium, cetrimide, dofanium chloride, tetraethylammonium bromide, didecyldimethylammonium chloride and domiphen bromide. These antiviral agents are provided in an amount in the range of 0.01 to 2 percent by weight of the total weight of the antiviral polymer, including all values and ranges therein.

In further aspects, the antiviral agents are organic and include phenols including those derived from herbal oils and extracts. For example, the antiviral agents include compounds such as echinacea, oregano, sage, basil, fennel, garlic, lemon balm, peppermint, rosemary, sambuca, licorice, astragalus, ginger, ginseng, dandelion, and additional phenols. Without being bound to any particular theory, it is believed the phenols and phenolic compounds interact with enveloped viruses and react with the envelope to kill them. Examples of phenols include chloroxylenol, syringic acid, gallic acid, tannic acid, and eugenol, which exhibit boiling points of greater than 250° C. These phenols are incorporated as antiviral agents into the antiviral polymer in an amount in the range of 5 to 20 percent by weight of the total weight of the antiviral polymer, including all values and ranges therein, such as 10 to 15 percent by weight, etc.

In aspects, the antiviral agents are dispersed uniformly through the base polymer. Uniform dispersion may be understood as the antiviral agent being present in at a given weight percent within plus or minus 0.01 weight percent of the given weight percent for any given volume of the antiviral polymer. In other aspects, the antiviral agent is present in domains dispersed in a matrix of the base polymer, wherein the concentration of the antiviral agent is relatively greater in the domains than in the base polymer matrix. In yet further aspects, the antiviral agents are present in domains exhibiting a cross-sectional geometry, wherein the cross-sectional geometry is consistent through the length L1 of the antiviral filament.

In some aspects, the antiviral filament also includes one or more additives combined in the base polymer such as carbon fibers, carbon nanoparticles, glass fibers, glass spheres, Kevlar fibers, nanocellulose fibers and crystals, as well as colorants, odorants, plasticizers, antioxidants, flame retardants, light and heat stabilizers, lubricants, pigments, antistatic agents, etc. The additives may be present in the antiviral polymer as well as in base polymer without antiviral agent if present in aspects of multicomponent filaments (described further herein). In aspects, the additives are present in an amount in the range of 0.1% to 25% of the total weight percent of the total weight of the polymer material, including all values and ranges therein.

In aspects, as illustrated in FIG. 1A, the three-dimensionally printable antiviral filament 10 is a monofilament. A monofilament is understood herein as a filament that exhibits consistent antiviral polymer composition throughout the cross-section 108 of the filament 10. In alternative aspects, the composition of the filament 10 may vary across the diameter D1 of the filament 10 or along the length L1 of the filament 10. In alternative aspects, such as illustrated in FIG. 1B, the three-dimensionally printable antiviral filament 100 is a multicomponent filament 100, including more than one polymer component, wherein at least one of the polymer components is an antiviral polymer. In the illustrated aspects, the multicomponent filament 100 is a multi-layer, or sheath-core, filament including a core 102 and a sheath 104, wherein the sheath 104 at least partially, and in aspects completely, surrounds the outer perimeter 106 of the core 102. The core 102 exhibits a diameter d2 that is in the range of 50% to 99.5% of the diameter of d1, including all values and ranges therein, such as 75% to 98%, 90% to 99.5%, 95% to 99.5%, etc. In addition, the sheath 104 is in the range of 0.5 microns to 200 microns in thickness t1, including all values and ranges therein, such as 20 microns to 100 microns in thickness, 0.5 to 50 microns in thickness, and preferably 30 microns to 50 microns, etc.

In aspects, the core 102 and sheath 104 are formed from different base polymers including the same or different antiviral agents. Alternatively, the core 102 and sheath 104 are formed from the same base polymer including the same or different antiviral agents. In other aspects, one of the core 102 and sheath 104 is formed from an antiviral polymer and the other of the core 102 or sheath 104 is formed from a polymer component include at least one of the base polymers noted above without an antiviral agent, wherein the base polymer of the core 102 and sheath 104 may be the same polymer or different polymers.

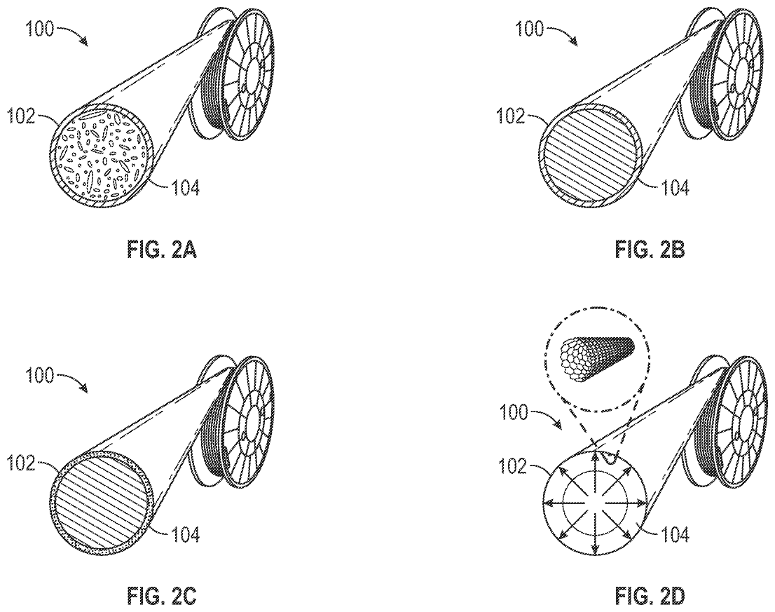

FIGS. 2A through 2D illustrate examples of a multicomponent filament 100 including a multilayer configuration. FIG. 2A illustrates an aspect including a fiber filled polymer core 102 enclosed in a sheath 104 including an antiviral polymer, wherein the sheath is a thermoplastic elastomer. FIG. 2B illustrates an aspect including a core 102 of a polymer material of thermoplastic urethane having a first hardness and a sheath 104 of an antiviral polymer of thermoplastic urethane including an antiviral agent having a second hardness, wherein the first hardness is less than the second hardness. FIG. 2C illustrates an aspect including a core 102 and sheath 104 formed of the same base polymer, wherein the concentration of carbon nanotubes or metal filled zeolite nanotubes and an antiviral agent increases from the core 102 to the sheath 104. FIG. 2D illustrates an aspect includes a polymer thermoplastic elastomer core 102 and an antiviral polymer sheath 104 of another base polymer and antiviral agent.

In aspects, the filaments 10, 100 are produced by extrusion. In some aspects, the core 102 and sheath 104 of a multicomponent filament 100 are extruded and formed at the same time, both passing through a single extruder die. In some aspects, the filament core 102 and sheath 104 are formed from a single base polymer, wherein the filament 100 contains a higher concentration of antiviral agents and, optionally other additives at the surface of the material by co-extruding multiple layers of a base polymer with varying concentrations of antiviral agent. In other aspects, the filament core 102 is formed by extrusion and, once solidified, the sheath 104 is formed over the core 102, either by coating the core 102 with the sheath 104 or by extruding the sheath 104 over the core 102, which is pulled through the extrusion die while forming the sheath 104. In other aspects, the sheath 104 is formed by forming a solution of the sheath polymer in a solvent and spraying, printing, dip coating, or otherwise coating the sheath polymer over the core 102.

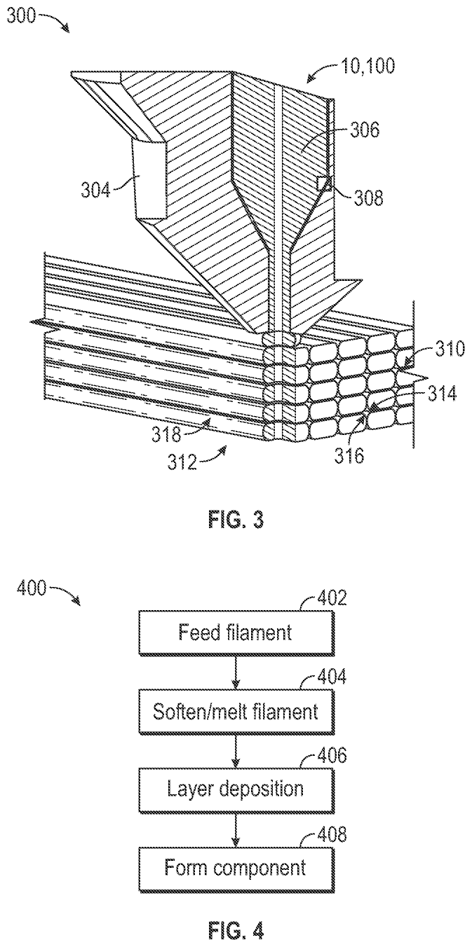

The printable filaments 10, 100 are then used in extrusion based additive manufacturing systems. FIG. 3 illustrates an aspect of a fused filament fabrication system, a 3D printer 300, and FIG. 4 illustrates a process 400 of fabricating a three-dimensional object with antiviral properties. While a multicomponent filament 100 is referenced herein, it should be appreciated that the 3D printer and method may be used with monofilament 10 as well. With references to FIGS. 3 and 4, the process 400 of fabrication begins at block 402, wherein the filament 100 is fed into an extrusion nozzle 304. In the extrusion nozzle 304, at block 404, the filament is softened, and in some cases melted, particularly at the sheath 104 if a multicomponent filament 100 is used, upon the application of heat and pressure in the extrusion nozzle 304. In the illustrated aspect, a neat polymer forming the core 102 is present in the center of the extrusion nozzle 306 and the antiviral sheath 104 is present at the wall 308 of the extrusion nozzle 304. The filament 100 is then deposited at block 406 into layers 310 of the filament 100, one on top of the other, to create, at block 408, a three-dimensional component 312. Antiviral surfaces 314 are present within the part pores 316 as well as on the exterior surfaces 318 of the component 312.

In aspects, the 3D printed components include, for example, masks for use in medical or laboratory settings, orthotics, prosthetics, or other medical devices and components used in a medical setting. Such components also include components are exposed to more than one user, such as factory floor tools, jigs, and fixtures, tooling components, as well as in shared office supplies such as staplers, pens, etc. In some aspects, it is contemplated that the antiviral agents will be effective in the components for at least six months after production.

Accordingly, aspects of the present disclosure are directed to an antiviral filament, including an antiviral polymer including a base polymer, and an antiviral agent incorporated in the base polymer, wherein the antiviral agent exhibits a phase transition temperature of 200 degrees Centigrade or greater.

In aspects, the antiviral agent includes at least one of metal nanoparticles, metal ions, and metal ion containing zeolites. In aspects, such antiviral agent is present in a range of 0.05 percent to 2 percent by weight of the total weight of the antiviral polymer. In aspects, such antiviral agent includes at least one of copper, gold, silver, an S block metal having a molecular mass greater than 28 and, a D block metal having a molecular mass greater than 28. In aspects, such antiviral agent includes metal nanoparticles and the metal nanoparticles exhibit a size in a range of 1 nm to 250 nm.

In any of the above aspects, the antiviral agent includes at least one of bisbiguanides, hypericin, pseudo-hypericin, quaternary ammonium salts and quaternary phosphonium salts. In aspects, such antiviral agent is present in the antiviral polymer in a range of 0.01 percent to 2 percent by weight of the total weight of the antiviral polymer. In aspects, such the antiviral agent includes phenols. In aspects, such antiviral agent is present in a range of 5 percent to 20 percent by weight of the total weight of the antiviral polymer. In aspects, such the phenols include tannic acid.

In any of the above aspects, the antiviral filament comprises a core and a sheath disposed on at least a portion of the core, wherein at least one of the sheath and the core is formed from the antiviral polymer. In aspects, the sheath and the core both include the same base polymer.

The present disclosure is also directed to methods of fabricating a three-dimensional component, comprising feeding any of the above aspects of an antiviral filament into an extrusion nozzle, applying heat and pressure to the antiviral filament to melt the antiviral filament in the extrusion nozzle, extruding the antiviral filament from the extrusion nozzle, depositing the extruded antiviral filament into layers, and forming a three-dimensional component from the layers of extruded antiviral filament.

The present disclosure is further directed to an antiviral three-dimensional printed component, including a plurality of layers of the antiviral filament according to any of the above aspects.

The 3D printed filaments including the antiviral sheaths of the present disclosure offer several advantages. These advantages may include, for example, providing antiviral activity continuously rather than having to rely upon wiping surfaces down. These advantages also include the ability to diversify end products and reduce the risk of maintaining business operations during epidemics and pandemics.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. An antiviral filament, comprising:
an antiviral polymer including
a base polymer, and
an antiviral agent incorporated in the base polymer, wherein the antiviral agent exhibits a phase transition temperature of 200 degrees Centigrade or greater.

2. The antiviral filament of claim 1, wherein the antiviral agent includes at least one of metal nanoparticles, metal ions, and metal ion containing zeolites.

3. The antiviral filament of claim 2, wherein the antiviral agent is present in a range of 0.05 percent to 2 percent by weight of the total weight of the antiviral polymer.

4. The antiviral filament of claim 2, wherein the antiviral agent includes at least one of copper, gold, silver, an S block metal having a molecular mass greater than 28 and, a D block metal having a molecular mass greater than 28.

5. The antiviral filament of claim 2, wherein the antiviral agent includes metal nanoparticles and the metal nanoparticles exhibit a size in a range of 1 nm to 250 nm.

6. The antiviral filament of claim 1, wherein the antiviral agent includes at least one of bisbiguanides, hypericin, pseudo-hypericin, quaternary ammonium salts and quaternary phosphonium salts.

7. The antiviral filament of claim 6, wherein the antiviral agent is present in the antiviral polymer in a range of 0.01 percent to 2 percent by weight of the total weight of the antiviral polymer.

8. The antiviral filament of claim 1, wherein the antiviral agent includes phenols.

9. The antiviral agent of claim 8, wherein the antiviral agent is present in a range of 5 percent to 20 percent by weight of the total weight of the antiviral polymer.

10. The antiviral filament of claim 8, wherein the phenols include tannic acid.

11. The antiviral filament of claim 1, wherein the antiviral filament comprises a core and a sheath disposed on at least a portion of the core, wherein at least one of the sheath and the core is formed from the antiviral polymer.

12. The antiviral filament of claim 11, wherein the sheath and the core both include the same base polymer.

13. A method of fabricating a three-dimensional component, comprising:
feeding an antiviral filament into an extrusion nozzle, the antiviral filament comprising an antiviral polymer including
a base polymer, and
an antiviral agent incorporated in the base polymer, wherein the antiviral agent exhibits a phase transition temperature of 200 degrees Centigrade or greater;
applying heat and pressure to the antiviral filament to melt the antiviral filament in the extrusion nozzle;
extruding the antiviral filament from the extrusion nozzle;
depositing the extruded antiviral filament into layers; and
forming a three-dimensional component from the layers of extruded antiviral filament.

14. An antiviral three-dimensional printed component, comprising:
a plurality of layers of an antiviral filament, the antiviral filament including an antiviral polymer including
a base polymer, and
an antiviral agent incorporated in the base polymer, wherein the antiviral agent exhibits a phase transition temperature of 200 degrees Centigrade or greater.

15. The antiviral filament of claim 14, wherein the antiviral agent includes at least one of metal nanoparticles, metal ions, and metal ion containing zeolites.

16. The antiviral filament of claim 15, wherein the antiviral agent is present in a range of 0.05 percent to 2 percent by weight of the total weight of the antiviral polymer.

17. The antiviral filament of claim 15, wherein the antiviral agent includes at least one of copper, gold, silver, an S block metal having a molecular mass greater than 28 and, a D block metal having a molecular mass greater than 28.

18. The antiviral filament of claim 15, wherein the antiviral agent includes metal nanoparticles, the metal nanoparticles exhibit a size in a range of 1 nm to 250 nm.

19. The antiviral filament of claim 14, wherein the antiviral agent includes at least one of bisbiguanides, hypericin, pseudo-hypericin, quaternary ammonium salts and quaternary phosphonium salts.

20. The antiviral filament of claim 19, wherein the antiviral agent is present in the antiviral polymer in a range of 0.01 percent to 2 percent by weight of the total weight of the antiviral polymer.

21. The antiviral filament of claim 14, wherein the antiviral agent includes phenols.

22. The antiviral agent of claim 21, wherein the antiviral agent is present in a range of 5 percent to 20 percent by weight of the total weight of the antiviral polymer.

23. The antiviral filament of claim 21, wherein the phenols include tannic acid.
